(19) United States
(12) Patent Application Publication
(10) Pub. No.: US 2019/0095437 A1
(43) Pub. Date: Mar. 28, 2019

(54) METHOD FOR USING MAINFRAME SYSTEM DATA IN OPEN SYSTEM IN REAL TIME

(71) Applicant: TMAXSOFT CO., LTD., Gyeonggi-do (KR)

(72) Inventors: Hyoung Woo PARK, Gyeonggi-do (KR); Seongbai JUN, Gyeonggi-do (KR); Wonjun JEONG, Gyeonggi-do (KR)

(21) Appl. No.: 16/144,011

(22) Filed: Sep. 27, 2018

(30) Foreign Application Priority Data
Sep. 28, 2017 (KR) 10-2017-0126072

(51) Int. Cl. G06F 17/30

(52) U.S. Cl. CPC G06F 17/30005; G06F 17/30418; G06F 17/30079; G06F 17/30076; G06F 17/30448

(57) ABSTRACT

Disclosed is a computer program stored in a computer readable storage medium including encoded commands. When the computer program is executed by one or more processors of a computer system, the computer program allows the one or more processor to perform the following steps and the following steps include: transmitting, by an open system, a record request to a mainframe system in order to query a record of the mainframe system; receiving, by the open system, record data as a response to the record request from the mainframe system; generating, by the open system, open system data by transforming the record data to a format usable in the open system; and providing, by the open system, the open system data to a user application.

### CROSS-REFERENCE TO RELATED APPLICATIONS

This application claims priority to and the benefit of Korean Patent Application No. 10-2017-0126072 filed in the Korean Intellectual Property Office on Sep. 28, 2017, the entire contents of which are incorporated herein by reference.

### TECHNICAL FIELD

The present disclosure relates to a compatibility of a mainframe system and an open system, and more particularly, to a data exchange between the mainframe system and the open system.

### BACKGROUND ART

A lot of mainframe systems were introduced in the 1960s to 1970s by the government, financial institutions and large corporations to handle various data needed for business activities. The mainframe system is a general-purpose large-scale computer that performs various tasks by adopting a centralized method of connecting a plurality of terminals to one computer and corresponds to, for example, IBM System/360 or the like. The mainframe system has been in continuous growth for over 30 years, leading to the enterprise computing industry. However, in the late 1980s, distributed environments in open systems such as Unix platforms began to emerge, and with downsizing to the open systems for saving system operating cost, a position of the mainframe system is greatly shaken.

The open system refers to a system which may be interconnected with and transplanted to a different type of computer because an interface is opened without depending on a closed technology and a program of a specific enterprise unlike the mainframe system and the open system corresponds to, for example, UNIX or the like.

In order to switch an application program and data which are operated in the mainframe system to the open system, a rapid and efficient data migration method is required, which minimizes manual work requirements by sufficiently understanding characteristics and concepts of data resources in the mainframe system. A hierarchical database, which is mainly used in the mainframe system, is a database in which data is managed in the form of a tree structure having a vertical dependent hierarchical relationship and for example, IMS/DB of IBM, ADM/DB of Hitachi, or the like which were commercialized in 1970s corresponds to the hierarchical database.

In the case of the hierarchical database, unlike relational databases currently used in most companies, it is necessary to know a data structure of the hierarchical database in order to extract data from a hierarchical database. However, a structure and a design of the hierarchical database are complex, and as a result, support by highly skilled computing personnel is required.

Migration requires a large amount of storage space in the open system and requires batch work. However, in the case of the migration, when the database is updated in the open system, there is a problem that the database needs to be transferred to the mainframe system again and even in this case, a large amount of network communication is required.

Therefore, there is a demand for a solution for inquiring and updating the data of the mainframe system in the open system in real time.

Korean Patent Registration No. 10-0869886 (Nov. 14, 2008) discloses a rehosting method that switches a mainframe system environment to an open system environment.

### SUMMARY OF THE INVENTION

The present disclosure has been made in an effort to easily inquire and update a data set of a mainframe in an open system.

An exemplary embodiment of the present disclosure provides a computer program stored in a computer readable storage medium, which includes encoded commands. The computer program allows one or more processors to perform the following steps when the computer program is executed by one or more processors of a computer system and the operations may include: transmitting, by an open system, a record request to a mainframe system in order to query a record of the mainframe system; receiving, by the open system, record data as a response to the record request from the mainframe system; generating, by the open system, open system data by transforming the record data to a format usable in the open system; and providing, by the open system, the open system data to a user application.

In an alternative exemplary embodiment, the record request may include a name and a record key of a data set stored in the mainframe system.

In an alternative exemplary embodiment, the record data as a part of the data set of the mainframe system may be a record of a specific row corresponding to the record key of the data set and may have a record structure of the mainframe system.

In an alternative exemplary embodiment, the generating of the open system data may include determining a data type of each field included in the record data by analyzing the record data by using a predetermined protocol, transforming a code system of each field from a mainframe system code system to an open system code system, and transforming the record data to open system data having a column based on the data type.

In an alternative exemplary embodiment, the predetermined protocol may include a Cobol copybook.

In an alternative exemplary embodiment, the transforming of the code system of each field from a mainframe system code system to an open system code system may include transforming an EBCDIC code of the field of the record data to an ASCII code.

In an alternative exemplary embodiment, the open system data may exist in a main memory of the open system and may not be stored in a persistent storage medium.

In an alternative exemplary embodiment, the steps may further include: receiving an update of a user for the open system data; generating updated record data by transforming the updated open system data to a format usable in the mainframe system; and transmitting the updated record data to the mainframe system so that the updated record data is stored in the mainframe system.

In an alternative exemplary embodiment, the steps may further include establishing, by the open system, a socket connection with the mainframe system through a network.

In an alternative exemplary embodiment, the steps may further include transmitting a query close signal to the mainframe system so as to close the data set in the mainframe system when the open system completes a record query of the mainframe system.

Another exemplary embodiment of the present disclosure provides an open system for using data of a mainframe system in real time. The open system may include: one or more processors; and a memory storing commands executable in the one or more processors, in which the one or more processors determine to transmit a record request to a mainframe system in order to query a record of the mainframe system in an open system, receive record data as a response to the record request from the mainframe system in the open system, generate open system data by transforming the record data to a format usable in the open system in the open system, and provide the open system data to a user application in the open system.

Yet another exemplary embodiment of the present disclosure provides a method for using data of a mainframe system in real time in an open system, which is performed in one or more processors of an open system. The method includes: transmitting, by an open system, a record request to a mainframe system in order to query a record of the mainframe system; receiving, by the open system, record data as a response to the record request from the mainframe system; generating, by the open system, open system data by transforming the record data to a format usable in the open system; and providing, by the open system, the open system data to a user application.

According to an exemplary embodiment of the present disclosure, it is possible to easily inquire and update a data set of a mainframe in an open system.

### BRIEF DESCRIPTION OF THE DRAWINGS

FIG. 1 is a block diagram of a mainframe system and an open system according to an exemplary embodiment of the present disclosure.

FIG. 2 is a flowchart of a method for using data of the mainframe system in real time in the open system according to an exemplary embodiment of the present disclosure.

FIG. 3 is a simple and normal schematic view of an exemplary computing environment in which the exemplary embodiments of the present disclosure may be implemented.

### DETAILED DESCRIPTION

Various exemplary embodiments will now be described with reference to drawings. In the present specification, various descriptions are presented to provide appreciation of the present disclosure. However, it is apparent that the exemplary embodiments can be executed without the specific description. In other examples, known structures and apparatuses are presented in a block diagram form in order to facilitate description of the exemplary embodiments.

“Component”, “module”, “system”, and the like which are terms used in the specification refer to a computer-related entity, hardware, firmware, software, and a combination of the software and the hardware, or execution of the software. For example, the component may be a processing process executed on a processor, the processor, an object, an execution thread, a program, and/or a computer, but is not limited thereto. For example, both an application executed in a computing device and the computing device may be the components. One or more components may reside in the processor and/or the execution thread and one component may be localized in one computer or distributed among two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

It should be appreciated that the word “comprises” and/or “comprising” means that the corresponding feature and/or component is present, but presence or addition of one or more other features, components, and/or a group thereof is not excluded. Further, when not separately specified or not clear in terms of the context that a singular form is indicated, it should be construed that the singular form generally means “one or more” in the present specification and the claims.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the embodiments presented herein, but should be analyzed within the widest range which is coherent with the principles and new features presented herein.

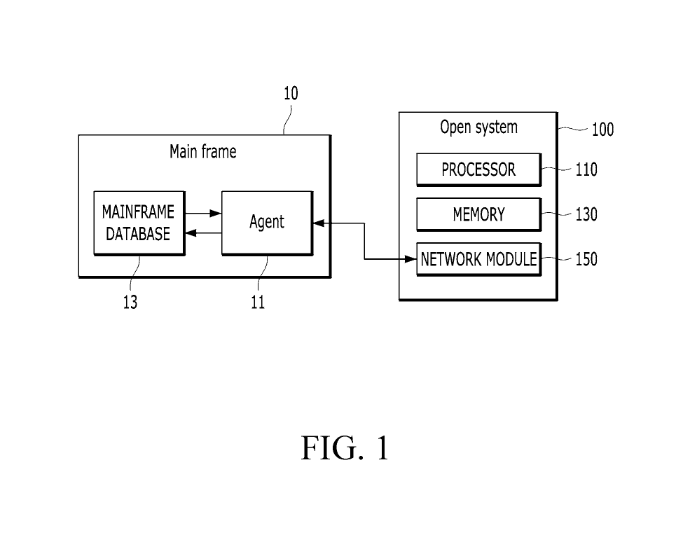

FIG. 1 is a block diagram of a mainframe system and an open system according to an exemplary embodiment of the present disclosure.

The mainframe system as an industrial term referring to a large-sized computer manufactured in a large company such as IBM is primarily used in a computing business required for enterprise activities of companies such as major companies or financial institutions and is configured by a centralization scheme rather than a distributed computing scheme. A program of the mainframe system may be created by a programming language such as Cobol or the like.

The open system may include predetermined program modules implemented in an open system environment (for example, Unix, Linux, etc.,) and perform functions of the mainframe system implemented through rehosting or perform functions of the open computing environment which is generally used.

The mainframe system 10 may include a mainframe database 13 and an agent 11. A configuration of the mainframe system 10 illustrated in FIG. 1 is only a simplified and illustrated example and in an exemplary embodiment of the present disclosure, the mainframe system 10 may include other components for configuring a computing environment of the mainframe system 10.

The mainframe database 13 is a term collectively referred to as one or more data sets stored in the mainframe system and may include all of raw data stored in the mainframe system. The mainframe database 13 follows a programming language system of the mainframe system 10 and may be configured with a code system of the mainframe system 10. For example, the mainframe database 13 may have a DBCDIC code system. The data set of the mainframe system may be a file holding a record organization. The data set may be organized into various logical records and block structures, which are determined by parameters including data set organization (DSORG), record format (RECFM), and the like. The data set may correspond to a table of a general relational database. The data set may include multiple records. The record may correspond to a specific row of the general relational database. A record key and a record number may correspond to indexes for identifying a specific record.

The agent 11 of the mainframe system 10 performs communication with the open system 100 and communicates with the mainframe database 13 to allow the mainframe database 13 to communicate with the open system 100. The mainframe system 10 and the open system 100 may establish a socket connection over a network. The mainframe system 10 and the open system 100 may perform socket communication by a TCP or UDP scheme. The agent 11 may become a connection point of the socket communication of the open system 100 and the mainframe system 10. The agent 11 may interpret a programming language system of the open system 100 and interpret the programming language system of the mainframe system 10 to support communication between the open system 100 and the mainframe system 10. The agent 11 may be a module for communication with the open system 100. The agent 11 may perform the socket communication with the open system 100. The mainframe system 10 and the open system 100 may exist as separate computing devices and perform communication by using network communication. The agent 11 may be a module that may decrypt information requested by the open system 100 and perform processing and response thereto.

The agent 11 may receive a record request from the open system 100. The open system 100 may be connected to the mainframe system 10 using address and port information of the mainframe system 10. When the open system 100 is connected, the agent 11 may transmit a message indicating that the open system 100 is normally connected to the open system 100. The record request may include a name and a record key of the data set stored in the mainframe system 10.

The record request of the present disclosure may include information for requesting a specific record stored in the mainframe system 10. The agent 11 may request to the mainframe database 13 a record identified by the record key in the data set identified by the name of the data set based on the name and the record key (or record number) of the data set. The name of the data set may include information for identifying the data set and the record key or the record number may include information for identifying which record among records included in the data set is requested. The record request may be created by a language of the open system 100 and the agent 11 may transform the language to the language of the mainframe system 10 and transfer the transformed language to the mainframe database 13.

The agent 11 may receive record data which the open system requests from the mainframe database 13 and transfer the received record data to the open system 100. The agent 11 may transfer each of the record data which the open system requests to the open system 100. The record data as a part of the data set of the mainframe system is a record of a specific row corresponding to the record key of the data set and may have a record structure of the mainframe system. The record data of the present disclosure may not be the entire database but data of some rows in the database. In the present disclosure, the open system 100 may request the mainframe system 10 only for the specific row required, rather than requesting the entire data set of the mainframe system 10. The open system 100 in the present disclosure requests only the specific row of the data set (i.e., the raw data stored in the mainframe system) of the mainframe system 10 and transforms the requested specific row to a format of the database of the open system 100 to provide the format to a user in real time and when the user modifies the corresponding row, modified matters may be transferred to the mainframe system 10 so that the modified matters are reflected to the raw data stored in the mainframe system 10.

The open system 100 may include a processor 110, a memory 130, and a network module 150. The configuration of the open system 100 illustrated in FIG. 1 is only a simplified and illustrated example and in an exemplary embodiment of the present disclosure, the open system 100 may include other components for configuring the computing environment of the open system 100.

The processor 110 may execute program codes stored in the memory 130. The processor 110 may include a CPU, a GPU, and the like including one or more cores and include a predetermined processing device for executing the program codes.

The memory 130 as a main memory of the open system 100 may include a storage space which may be occupied by loaded processors of the open system 100. In an exemplary embodiment of the present disclosure, the memory 130 may include a volatile memory which is distinct from a persistent storage medium.

The network module 150 may include a communication module which may communicate with the mainframe system 10. The network module 150 may become the connection point in the socket communication between the mainframe system 10 and the open system 100. The network module 150 may communicate with the mainframe system 10 through the network. The network module 150 may transmit the record request to the mainframe system 10 and receive the record data from the mainframe system 10.

The processor 110 transforms the record data to a format usable in the open system to generate open system data. The database of the mainframe system 10 may be a hierarchical database type. The database of the mainframe system 10 is a database in which data is managed in a tree structure form having a vertical dependent hierarchical relationship and corresponds to, for example, IMS/DN of IBM, ADM/DB of Hitachi, or the like. The aforementioned database of the mainframe system 10 is just an example and the present disclosure is not limited thereto. The open system 100 may generally have a relational database structure. The mainframe system 10 and the open system 100 may have different database structures and have different data code systems. Therefore, in order to use the record of the main frame database in the open system 100, it may be necessary to analyze and transform the record.

The processor 110 may determine a data type of each field included in the record data by analyzing the record data by using a predetermined protocol. The predetermined protocol may include a Cobol copybook. The Cobol copybook may be a set of variables defined as a purpose for inputting and outputting the data of the database in a Cobol application program. The Cobol copybook may be predetermined information indicating which data type each part of the record data has. For example, when the record data is consecutive data of a specific row without column division, the processor 110 may determine which data type each part of the consecutive data of the record data has by using the copybook. The Cobol copybook may include respective fields constituting the data record and definitions of formats, lengths, and the like of the fields. For example, record data including Hong Gil-dong (column 1, name), employee (column 2, rank), and 25 million won (column 3, salary) may be 16-byte consecutive data in which columns 1 to 3 corresponding to the name, the rank, and the salary are not distinguished. In this case, the processor 110 may determine that the data type of the field up to 4 bytes is a character because first 1 to 4 bytes of 16 bytes are the data of the column 1 corresponding to the name using the Cobol copybook, the data type of the corresponding field is the character because the next 5 to 10 bytes are data of column 2, and the data type of the corresponding field is a number because the next 11 to 16 bytes is data of column 3. The aforementioned record is just an example and the present disclosure is not limited thereto. Further, the predetermined protocol may include an INCLUDE file of the mainframe system. The aforementioned protocol is just an example and the present disclosure is not limited thereto.

The processor 110 may transform the code system of each field from a mainframe system code system to an open system code system. The processor 110 may transform an EBCDIC code to an ASCII code in the case of character string data of the record data field or transform a PACKED-DECIMAL, ZONED-DECIMAL, or BINARY code to a numeric type character code in the case of numeric string data.

The processor 110 may transform the record data to open system data having a column based on the data type. Like the aforementioned example, the processor 110 makes each field of the record correspond to each column of the open system database and matches each field in the record corresponding to the row with each column to transform each field to open data. For example, record data including Hong Gil-dong (column 1, name), employee (column 2, rank), and 25 million won (column 3, salary) may be 16-byte consecutive data in which columns 1 to 3 corresponding to the name, the rank, and the salary are not distinguished. In this case, the processor 110 may determine that the data type of the field up to 4 bytes is a character because first 1 to 4 bytes of 16 bytes are the data of the column 1 corresponding to the name using the Cobol copybook, the data type of the corresponding field is the character because the next 5 to 10 bytes are data of column 2, and the data type of the corresponding field is a number because the next 11 to 16 bytes is data of column 3. The processor 110 may generate the open system data in which each field matches the column of the database with the data of 1 to 4 bytes of the record data as the data of column 1, the data of 5 to 10 bytes of the record data as the data of column 2, and the data of 11 to 16 bytes of the record data as the data of column 3 based on the data type.

The generated open system data may be stored in the main memory 130 of the open system and may not be stored in a persistent storage medium (not illustrated). The generated open system data may exist in the main memory 130 of the open system as a process which a user application may refer to. The processor 110 allows the user application to refer to the generated open system data to allow the user of the open system to use the record stored in the mainframe system. The open system according to an exemplary embodiment of the present disclosure does not store the record data and the open system data in the persistent storage medium unlike the migration or the like, but locates the record data and the open system data in the memory to allow the user to use the record data and the open system data in real time.

The processor 110 may receive an update of the user for the open system data. The user may use the open system data in the user application and modify the open system data. In this case, the processor 110 may reflect the updated open system data to the mainframe system database. To this end, the processor 110 transforms the updated open system data to the format usable in the mainframe system 10 to generate the updated record data. A process of transforming the aforementioned updated open system data to the updated record data may be a process of reversing the process of transforming the record data to the open system data. The processor 110 may determine to transmit the updated record data to the mainframe system 10 so that the updated record data may be stored in the mainframe system 10 and the network module 150 may transmit the updated record data to the mainframe system 10 according to the determination of the processor 110.

The processor 110 may cause the mainframe system 10 to close the data set being opened when a record query of the mainframe system 10 is completed in the open system 100. In this case, the network module 150 may transmit a query close signal to the mainframe system 10 according to the determination of the processor. The mainframe system 10 that receives the query close signal may close the data set which is currently queried. In addition, the mainframe system 10 and the open system 100 may close the established socket communication.

As described in an exemplary embodiment of the present disclosure, when only a record required by the user is provided to the user without migrating the entire mainframe system database, a storage space for replicating the entire database of the mainframe system is not required in the open system, thereby reducing the storage space. Further, the open system according to an exemplary embodiment of the present disclosure does not need to perform a batch process for replicating the entire database of the mainframe system, thus reducing network bandwidth usage as compared with migration and reducing computing power. In addition, when the user modifies the queried database record of the mainframe system, the open system according to an exemplary embodiment of the present disclosure may reflect the modified database record to the database (i.e., the raw data) of the mainframe system in real time, thereby using stability and high reliability effects of the mainframe system.

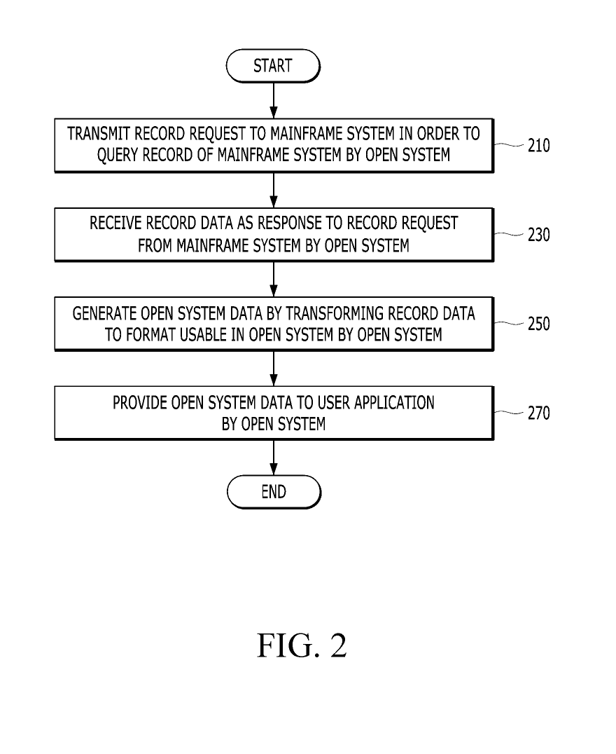

FIG. 2 is a flowchart of a method for using data of the mainframe system in real time in the open system according to an exemplary embodiment of the present disclosure.

The open system 100 may transmit the record request to the mainframe system in order to query the record of the mainframe system 10 (210). The record request of the present disclosure may include information for requesting a specific record stored in the mainframe system 10. The name of the data set may include information for identifying the data set and the record key or the record number may include information for identifying which record among records included in the data set is requested. The record request may be created by a language of the open system 100 and the mainframe system 10 interprets the created language of the open system 100 as the mainframe system language to process the request.

The open system 100 may receive the record data as a response to the record request from the mainframe system 10 (230). The record data as a part of the data set of the mainframe system is a record of a specific row corresponding to the record key of the data set and may have a record structure of the mainframe system. The record data of the present disclosure may not be the entire database but data of some rows in the database. In the present disclosure, the open system 100 may request the mainframe system 10 only for the specific row required, rather than requesting the entire data set of the mainframe system 10. The open system 100 in the present disclosure requests only the specific row of the data set (i.e., the raw data stored in the mainframe system) of the mainframe system 10 and transforms the requested specific row to a format of the database of the open system 100 to provide the format to a user in real time and when the user modifies the corresponding row, modified matters may be transferred to the mainframe system 10 so that the modified matters are reflected to the raw data stored in the mainframe system 10.

The open system 100 transforms the record data to the format usable in the open system to generate the open system data (250). The database of the mainframe system 10 may be a hierarchical database type. The database of the mainframe system 10 is a database in which data is managed in a tree structure form having a vertical dependent hierarchical relationship and corresponds to, for example, IMS/DN of IBM, ADM/DB of Hitachi, or the like. The aforementioned database of the mainframe system 10 is just an example and the present disclosure is not limited thereto. The open system 100 may generally have a relational database structure. The mainframe system 10 and the open system 100 may have different database structures and have different data code systems. Therefore, in order to use the record of the mainframe database in the open system 100, it may be necessary to analyze and transform the record.

The open system 100 may determine a data type of each field included in the record data by analyzing the record data by using a predetermined protocol. The predetermined protocol may include Cobol copybook. The Cobol copybook may be a set of variables defined as a purpose for inputting and outputting the data of the database in a Cobol application program. The Cobol copybook may be predetermined information indicating which data type each part of the record data has.

The open system 100 may transform the code system of each field from a mainframe system code system to an open system code system. The open system 100 may transform an EBCDIC code to an ASCII code in the case of character string data of the record data field or transform a PACKED-DECIMAL, ZONED-DECIMAL, or BINARY code to a numeric type character code in the case of numeric string data.

The open system 100 may transform the record data to open system data having a column based on the data type.

The generated open system data may be stored in the main memory 130 of the open system and may not be stored in a persistent storage medium (not illustrated). The generated open system data may exist in the main memory 130 of the open system as a process which a user application may refer to. The processor 110 allows the user application to refer to the generated open system data to allow the user of the open system to use the record stored in the mainframe system. The open system according to an exemplary embodiment of the present disclosure does not store the record data and the open system data in the persistent storage medium unlike the migration or the like, but locates the record data and the open system data in the memory to allow the user to use the record data and the open system data in real time.

The open system 100 provides the open system data to the user application to allow the user to use the open system data (270).

The open system 100 may receive the update of the user for the open system data. The user may use the open system data in the user application and modify the open system data. The open system 100 may reflect the updated open system data to the mainframe system database. To this end, the open system 100 transforms the updated open system data to the format usable in the mainframe system 10 to generate the updated record data. A process of transforming the aforementioned updated open system data to the updated record data may be a process of reversing the process of transforming the record data to the open system data. The open system 100 may transmit the updated record data to the mainframe system 10 so that the updated record data may be stored in the mainframe system 10.

The open system 110 may cause the mainframe system 10 to close the data set being opened when a record query of the mainframe system 10 is completed. The open system 100 may transmit the query close signal to the mainframe system 10. The mainframe system 10 that receives the query close signal may close the data set which is currently queried. In addition, the mainframe system 10 and the open system 100 may close the established socket communication.

As described in an exemplary embodiment of the present disclosure, when only a record required by the user is provided to the user without migrating the entire mainframe system database, a storage space for replicating the entire database of the mainframe system is not required in the open system, thereby reducing the storage space. Further, the open system according to an exemplary embodiment of the present disclosure does not need to perform a batch process for replicating the entire database of the mainframe system, thus reducing network bandwidth usage as compared with migration and reducing computing power. In addition, when the user modifies the queried database record of the mainframe system, the open system according to an exemplary embodiment of the present disclosure may reflect the modified database record to the database (i.e., the raw data) of the mainframe system in real time, thereby using stability and high reliability effects of the mainframe system.

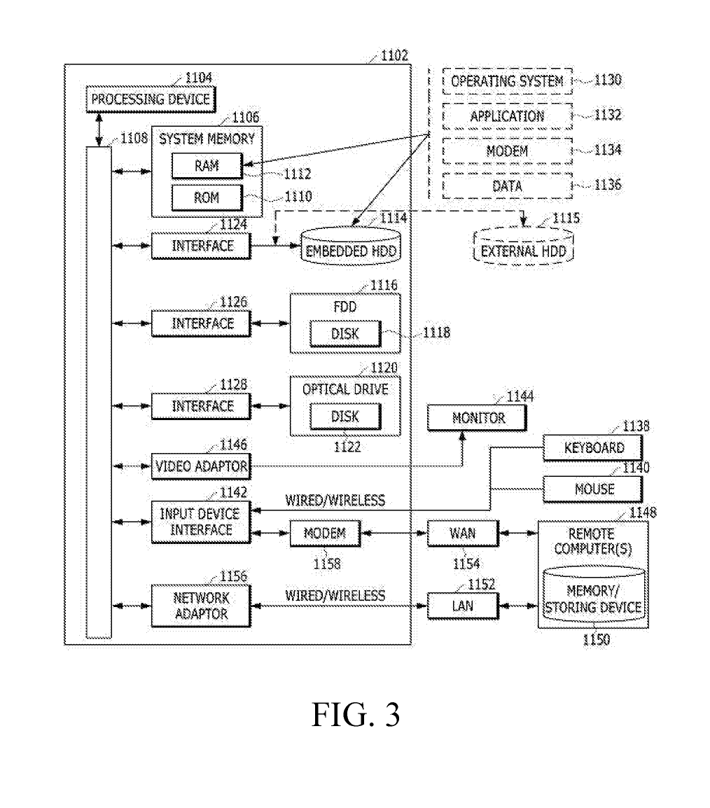

FIG. 3 is a simple and normal schematic view of an exemplary computing environment in which the exemplary embodiments of the present disclosure may be implemented.

The present disclosure has generally been described above in association with a computer executable command which may be executed on one or more computers, but it will be well appreciated by those skilled in the art that the present disclosure can be implemented through a combination with other program modules and/or a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As not a limit but an example, the computer readable media may include both computer readable storage media and computer readable transmission media. The computer readable storage media include volatile and non-volatile media, temporary or non-temporary media, and movable and non-movable media implemented by a predetermined method or technology for storing information such as a computer readable command, a data structure, a program module, or other data. The computer storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by configuring or changing at least one of characteristics of the signal so as to encode information in the signal. As not a limit but an example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor or other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable command, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached by the RAM 1112. It will be well appreciated that the present disclosure may be implemented in various operating systems which are commercially usable or a combination of the operating systems.

A user may input commands and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes a speaker, a printer, and other peripheral output devices (not illustrated).

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and a Bluetooth wireless technology. Accordingly, communication may be a predefined structure like the network in the related art or just ad hoc communication between at least two devices.

The Wi-Fi enables connection to the Internet, and the like without a wired cable. The Wi-Fi is a wireless technology such as a device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as “software”), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be analyzed that the implementation determination departs from the scope of the present disclosure.

Various exemplary embodiments presented herein may be implemented as manufactured articles using a method, an apparatus, or a standard programming and/or engineering technique. The term “manufactured article” includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but it does not mean that the method claims are limited to the presented specific order or hierarchical structure.

The description of the presented embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the embodiments presented herein, but should be analyzed within the widest range which is coherent with the principles and new features presented herein.

What is claimed is:

1. A computer program stored in a computer readable storage medium, which includes encoded commands, wherein when the computer program is executed by one or more processors of a computer system, which allows the one or more processors to perform the following steps, the steps comprising:
transmitting, by an open system, a record request to a mainframe system in order to query a record of the mainframe system;
receiving, by the open system, record data as a response to the record request from the mainframe system;
generating, by the open system, open system data by transforming the record data to a format usable in the open system; and
providing, by the open system, the open system data to a user application.

2. The computer program of claim 1, wherein the record request includes a name and a record key of a data set stored in the mainframe system.

3. The computer program of claim 2, wherein the record data as a part of the data set of the mainframe system is a record of a specific row corresponding to the record key of the data set and has a record structure of the mainframe system.

4. The computer program of claim 1, wherein the generating of the open system data includes
determining a data type of each field included in the record data by analyzing the record data by using a predetermined protocol,
transforming a code system of each field from a mainframe system code system to an open system code system, and
transforming the record data to open system data having a column based on the data type.

5. The computer program of claim 4, wherein the predetermined protocol includes a Cobol copybook.

6. The computer program of claim 4, wherein the transforming of the code system of each field from a mainframe system code system to an open system code system includes transforming an EBCDIC code of the field of the record data to an ASCII code.

7. The computer program of claim 1, wherein the open system data exists in a main memory of the open system and is not stored in a persistent storage medium.

8. The computer program of claim 1, the steps further comprising:
receiving an update of a user for the open system data;
generating updated record data by transforming the updated open system data to a format usable in the mainframe system; and
transmitting the updated record data to the mainframe system so that the updated record data is stored in the mainframe system.

9. The computer program of claim 1, the steps further comprising:
establishing, by the open system, a socket connection with the mainframe system through a network.

10. The computer program of claim 1, the steps further comprising:
transmitting a query close signal to the mainframe system so as to close the data set in the mainframe system when the open system completes a record query of the mainframe system.

11. An open system for using data of a mainframe system in real time in an open system, the open system comprising:
one or more processors; and
a memory storing commands executable in the one or more processors,
wherein the one or more processors
determine to transmit a record request to a mainframe system in order to query a record of the mainframe system in an open system,
receive record data as a response to the record request from the mainframe system in the open system,
generate open system data by transforming the record data to a format usable in the open system in the open system, and
provide the open system data to a user application in the open system.

12. A method for using data of a mainframe system in real time in an open system, which is performed in one or more processors of an open system, the method comprising:
transmitting, by an open system, a record request to a mainframe system in order to query a record of the mainframe system;
receiving, by the open system, record data as a response to the record request from the mainframe system;
generating, by the open system, open system data by transforming the record data to a format usable in the open system; and
providing, by the open system, the open system data to a user application.
